(19) United States
(12) Patent Application Publication
(10) Pub. No.: US 2026/0296708 A1
(43) Pub. Date: Oct. 1, 2026

(54) DEVICES AND METHODS FOR HANDLING FLEXIBLE LARGE-VOLUME RECEPTACLES CONTAINING BULK MATERIAL

(71) Applicant: MHWIRTH AS, Kristiansand (NO)

(72) Inventors: Peter Edward DAVEY, Røyken (NO); Joar WIGGEN, Oslo (NO)

(21) Appl. No.: 19/480,809

(22) PCT Filed: Apr. 19, 2024
(86) PCT No.: PCT/NO2024/050095

§ 371 Date: Nov. 1, 2025

(30) Foreign Application Priority Data
May 3, 2023 (NO) 20230515

(51) Int. Cl. B65B 69/00

(52) U.S. Cl. CPC B65B 69/0083; B65B 69/0008

(57) ABSTRACT

Handling device (1) for handling flexible receptacles (30) containing bulk material, the device comprising a support frame (2) with at least one opening (3), wherein the support frame (2) is configured to support a receptacle bottom of a loaded receptacle; and a cutter (5) at least partially protruding into the opening (3) of the support frame (2) and configured to cut the receptacle bottom; wherein the cutter (5) is a rotary cutter (5) with a circular blade (6) defining a rotational plane (R). There is also provided a method for handling flexible receptacles (30) containing bulk material.

The present disclosure relates to devices and methods for handling flexible large-volume receptacles, e.g. flexible intermediate bulk containers (FIBC) which are also called big bags. In particular, the present disclosure relates to devices and methods for discharging bulk material from flexible large-volume receptacles.

### BACKGROUND

Although it is also common to store bulk materials as powder or granules in rigid containers, flexible large-volume receptacles are increasingly used as enclosure and packaging for these pourable substances. Flexible receptacles with a volume capacity of 0.5 m³ and more are commonly known as big bags. Big bags are usually handled, e.g. transported, by means of machines due to their high weight in a filled state, which can range from several hundred kilograms to a few tons.

For the same reason, not only the transport, but also the stationary handling as filling and emptying of big bags presents manipulation challenges. Furthermore, the enclosed powdery material may cause contaminations to the environment in the moment of filling or emptying the big bag, which is particularly undesirable in case of harmful or toxic substances. Usually, the bulk material is discharged from a provided outlet port or cut hole at the bottom of the big bag under the influence of gravity.

Flexible large-volume receptacles may, for instance, be used in product manufacturing industries, in waste management, and also on drilling sites, where it may be required to supply powdery material as additive for the preparation of drilling fluids. These additives are typically supplied in large quantities and may present challenges regarding dust exposure upon their discharge from large-volume receptacles.

In the past, efforts were already made to improve the emptying process of big bags, and devices have been provided to facilitate the stationary handling and to reduce contamination.

For example, US 2004/074922 A1 discloses an emptying device for large-volume receptacles with a lifting mechanism to ensure complete emptying and a shutter mechanism for allowing a clean and controlled gradual emptying. EP 2 644 520 A1 relates to a device for emptying flexible containers which can be detachably fastened to the container. The device comprises a negative pressure chamber with suction openings for essentially contamination-free discharge of the contained material. Furthermore, the device optionally comprises a cutting knife having a cross-shaped blade arrangement and a lifting mechanism for being moved upwardly towards the container in order to pierce it open.

Still, available devices as described according to the cited prior art provide relatively cumbersome handling techniques with quite extended operation times and sensitive components. Especially in rough environments as the above-mentioned drilling sites, a need exists to provide handling methods and devices which are improved regarding their robustness, reliability and operating speed and which provide enhanced dust protection for staff health and safety. The present disclosure has the objective to provide technology with improvements in one or more of the above areas, or at least forming a useful alternative to the state of the art.

### SUMMARY

In an embodiment, there is provided a handling device for handling flexible receptacles containing bulk material, the device comprising: a support frame with at least one opening, wherein the support frame is configured to support a receptacle bottom of a loaded receptacle; and a cutter at least partially protruding into the opening of the support frame and configured to cut the receptacle bottom; wherein the cutter is a rotary cutter with a circular blade defining a rotational plane.

In an embodiment, there is provided a method for handling flexible receptacles containing bulk material.

The detailed description below and appended claims outline further inventive aspects and embodiments.

### BRIEF DESCRIPTION OF THE DRAWINGS

The above and other characteristics will become clear from the following description of illustrative, non-restrictive examples, with reference to the attached drawings, in which:

FIG. 1 provides a perspective front view of a handling device according to a first example.

FIG. 2 provides a top view of the handling device according to the first example.

FIG. 3 provides a cut side view of the handling device according to the first example.

FIG. 4 provides a cut side view of the handling device according to a second example.

FIG. 5 provides a front view of the handling device according to the first example.

FIG. 6 provides a perspective front view of a handling device according to another example

FIGS. 7-13 illustrate aspects of an example of a handling device having an internal sack handling mechanism.

### DETAILED DESCRIPTION

The following description may use terms such as “horizontal”, “vertical”, “upwardly”, “downwardly”, etc. These terms generally refer to the views and orientations as shown in the drawings and that are associated with a normal use of the invention. The terms are used for the reader's convenience only and shall not be limiting.

The present description provides improved handling devices and improved handling methods for the manipulation and particularly the emptying of flexible large-volume receptacles as big bags having a capacity of more than 0.5 m³. For example on drilling rigs, these receptacles may contain powdery additives for the on-site preparation of drilling fluids. The additives may tend to create dust in the direct surroundings of the receptacles upon discharge. Furthermore, due to operational demands, quick and effective emptying of the receptacles may be required for fluent work processes. In addition, the rough environment on drilling rigs, especially if located offshore, requires robust and effective handling devices reliably functioning for a long period under challenging environmental conditions. Nevertheless, other areas of big bag application may also experience one or more of the aforementioned requirements, such that the suggested inventive handling devices and methods are not limited to usage on drilling rigs.

In this context, for example in the abovementioned EP 2 644 520 A1, suction means for dust limitation and cutting means for piercing the receptacle in order to start discharge are suggested. Nevertheless, the operation time for loading the receptacle, lifting and retracting the cutting means and performing the suctioning is relatively high and the cutting and suctioning components may be prone to faults as insufficient cutting openings or clogging. Therefore, it is one of the objectives of the present invention to provide fast, reliably and efficiently working handling devices and methods overcoming the drawbacks of the prior art.

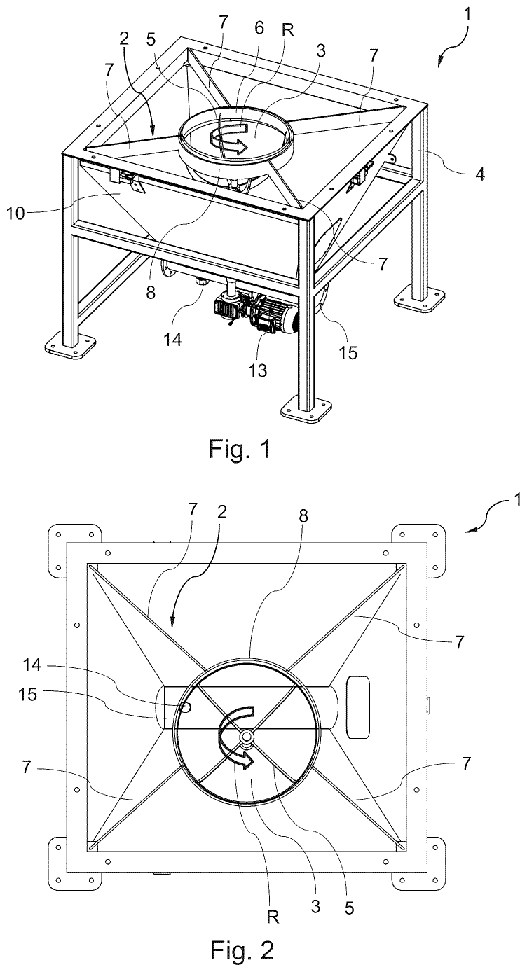

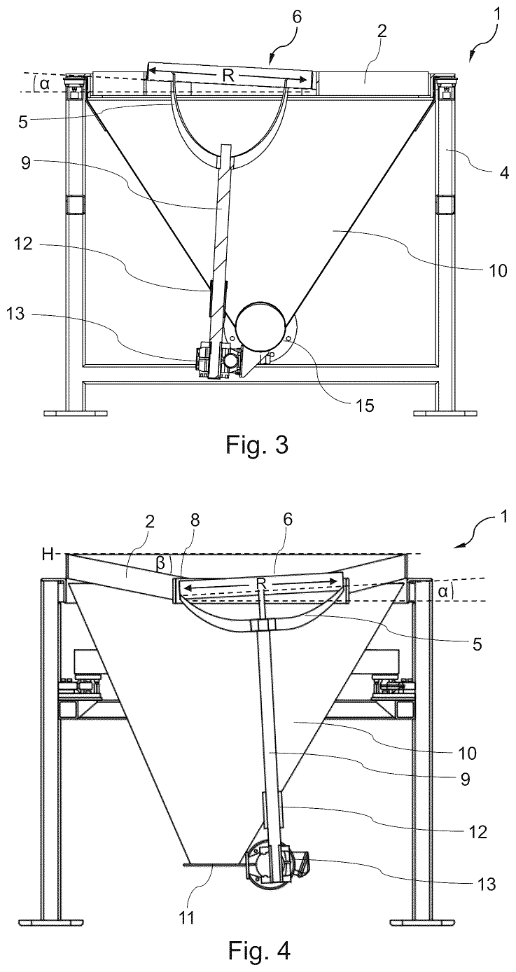

FIGS. 1 to 5 provide various views of handling devices 1 according to example embodiments. In particular, FIGS. 1 to 3 and 5 show a handling device 1 according to a first example and FIG. 4 shows a handling device 1 according to a second example, as will be described in detail below with reference to FIGS. 3 and 4.

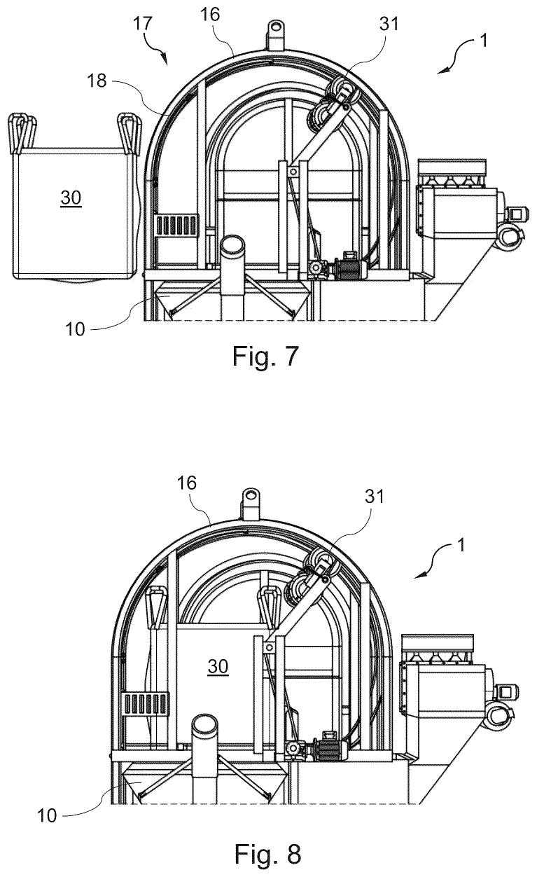

Turning to FIGS. 1 and 2, a perspective top view and a direct top view are provided illustrating a handling device 1 for handling flexible large-volume receptacles containing bulk material (not shown in FIGS. 1 and 2 but illustrated in relation to FIGS. 7-8 below, see item 30). For instance, the flexible large-volume receptacle may contain powdery material. By means of the handling device 1, the powdery material may be discharged from the receptacle and supplied to a target container, a supply line or other suitable receiving objects. The handling device 1 comprises a support frame 2 mounted on a rack 4. The rack 4 is configured to hold and stabilize the support frame 2 at a suitable height. The support frame 2 is configured to support a receptacle bottom of a flexible large-volume receptacle which is loaded onto the support frame 2.

The support frame 2 comprises at least one opening 3 to allow for discharging the receptacle through the support frame 2. The opening 3 is dimensioned sufficiently small to not affect the stability of a loaded receptacle resting on the support frame 2. For instance and in accordance with the depicted example, the opening 3 may be circular. According to alternative examples, the opening 3 may be rectangular or comprise an irregular geometrical shape.

As illustrated, the handling device 1 comprises a cutter 5 which at least partially protrudes into the opening 3 of the support frame 2. By means of the cutter 5, the receptacle bottom is cut in order to initiate the discharge of bulk material from the receptacle. In contrast to cutter concepts usually used for handling devices 1 of the described kind and in accordance with the invention, the cutter 5 is a rotary cutter 5. The rotary cutter 5 comprises a circular blade 6, the circular blade contour defining a rotational plane R. By means of a rotary cutter 5, a fast, effective and reliable cutting of the receptacle bottom can be achieved. The operation time of cutting is significantly reduced as the cutter 5 already projects into the opening 3 next to the receptacle bottom and as the circular blade 6 cuts the receptacle accurately and simultaneously at various points on a continuous line. Occasional blunt spots on the blade 6, e.g. due to wear effects, can be compensated by the rotational movement. Thus, the cutting is improved with regard to robustness and speed compared to known cutting concepts for handling devices 1.

The rotary cutter 5 may be powered by a suitable cutter drive 13, e.g. an electrical or hydraulic motor. The rotary cutter 5 may be connected to the cutter drive 13 via an elongated cutter shaft 9 extending inside the rack 4 (see FIGS. 3 and 4), the circular blade 6 being connected to the cutter shaft 9 by means of at least one blade holder. The blade 6 may be configured to rotate centrally about the longitudinal axis of the cutter shaft 9. Nevertheless, eccentrical rotation concepts may be also applicable such that the blade 6 has a varying distance to the receptacle bottom upon rotation.

The cutter shaft 9 may advantageously be adjustable in its length, such that the cutter height above ground or in relation to the support frame 2 is adaptable by means of the adjustable cutter shaft 9. In addition or alternatively, the cutter shaft 9 may be adjustable in its setting angle, such that the cutter angle and, if present, the inclination angle α are adaptable by means of the adjustable cutter shaft 9. According to other examples, the inclination angle α may be separately adjustable, e.g. by means of an adaptable blade holder. With an adjustable cutter shaft 9, individual cutting configurations can be implemented and the cutting process may be optimized for different receptacle characteristics, e.g. varying receptacle thicknesses, weights, dimensions or geometries, or the cutter may be adjustable to different predefined operation parameters as cutting speed, cut opening size, etc. For instance, the cutter shaft length may be adjusted by a telescopic mechanism, a linear guidance mechanism or other suitable mechanical length adjustment means, and the cutter angle may be adjusted by a suitable swivel.

The blade 6 may be rotated selectively upon a respective power signal in a predefined direction of rotation. Depending on the configuration, the cutter 5 may be set up to rotate only in one direction or in two opposite directions, e.g. with periodic direction changes such that the blade 6 may also oscillate if required or useful. The blade 6 may, for instance, be configured as a cutting blade with an even cutting edge or as a saw blade with a toothed cutting edge. Furthermore, the blade 6 may be detachably connected to the blade holder of the cutter 5, thus allowing for blade exchange or maintenance due to wear or for exchange to a different blade diameter or blade type according to individual requirements.

The support frame 2 may comprise struts, grids, plates or any other mechanical structure suitable to support flexible large-volume receptacles. With regard to the example depicted in FIGS. 1 and 2, four converging support struts 7 arranged in a substantially cruciform manner are used to provide a stable and robust support frame 2. The space between the support struts 7 form further openings 3 in addition to the opening 3 into which the cutter 5 is projecting. Thus, swirling or floating material is allowed to fall through the support frame 2.

As illustrated in FIGS. 1 and 2, the support frame 2 comprises a circular subframe 8 into which the cutter 5 projects. The circular subframe 8 rims the circular blade 6, preferably on the whole circumference. By means of the subframe 8, it is ensured that the receptacle bottom is properly supported in the cutting area and that the blade 6 is protected from the high weight load of the receptacle, thus preventing blade deformation. Depending on a selected frame configuration, the subframe 8 may be arranged centrally of the support frame 2 or eccentrically as depicted in FIG. 2. According to the illustrated example, the subframe 8 connects the converging support struts 7 by forming a joint circular frame part.

Now turning to FIGS. 3 and 4, cut side views show the first and a second examples of the handling device 1. As indicated by the marked angle α, the rotational plane R of the cutter blade 6 is inclined to the support frame 2. By providing an inclined rotational plane R, it is ensured that the circular blade 6 is only partially exposed to the receptacle bottom. Thus, it is prevented that the circular blade 6 cuts a complete circular section off the receptacle, which cut-off section of receptacle material could fall through the support frame 2 and contaminate the discharged bulk material or disturb downstream equipment. With an inclined rotational plane R of the circular blade 6, a geometrically unclosed arc is cut into the receptacle bottom, thus providing a sufficiently large opening in the receptacle for fast material discharge. Preferably, the inclination angle α is an acute angle in a range between 1° and 15°, in a range between 2° and 10° or in a range between 3° and 5°. With reference to the partial circumference of the circular blade 6 exposed to the receptacle bottom, for instance a segment of 310° to 350°, 320° to 340° or approximately 330° may be exposed. The blade segment which is not configured for exposure to the receptacle may be arranged below (i.e. vertically lower than) the supporting level of the support frame 2 such that a cutting contact between the non-exposed blade segment and the receptacle bottom is prevented. The inclined rotational plane R may be oriented upwardly or downwardly from the support frame 2 depending on the support frame 2 configuration, as long as it is ensured that the circular blade 6 reaches the receptacle bottom and that the receptacle bottom is only partially contacted by the circular blade 6.

With reference to FIG. 3, the first example comprises a horizontal support frame 2. The term “horizontal” implies that the support frame 2 is substantially extending parallel to the flat ground when the handling device 1 is properly erected and in a normal use orientation. The support frame 2 may define a support plane, e.g. by conceptual connection of the support struts 7, and the support plane may extend in a direction substantially perpendicular to vertical rack struts by which the support frame 2 is distanced to the ground. The term “vertical” implies that the rack struts extend substantially perpendicular to the ground. The support plane may define the orientation of the support frame 2 such that a horizontal support plane corresponds to a horizontal support frame 2.

With reference to FIG. 4, the second example comprises a support frame 2 of which at least a section is tilted to the horizontal H at a predefined tilt angle β. By means of a tilted support frame 2, the receptacle bottom of a loaded flexible large-volume receptacle will arch or bend into the formed slope, thus promoting an improved emptying process compared to a flat support surface provided by the support frame 2. The horizontal H may be an imaginary line parallel to the flat ground or to a horizontally extending part of the support frame 2 or of the rack 4. The tilt angle β may be a larger angle than the inclination angle α but less than 45°, preferably less than 30°. According to alternative examples, the tilt angle β may be equal or less than the inclination angle α. Furthermore, it is conceivable that more than one section of the support frame 2 is tilted, and that the sections are tilted at equal or at different tilt angles β. For example, the support frame 2 may comprise various support struts 7 which are tilted at differing tilt angles β. As can be taken from FIG. 4, the rotational plane R of the blade 6 may still be inclined to the support frame 2 or to at least one support strut 7 at a predefined inclination angle α, thus ensuring that the circular blade 6 is only partially exposed to the receptacle bottom.

Depending on a selected frame configuration, the circular subframe 8 framing the circular blade 6 may be coincidently inclined with the rotational plane R, it may comprise a larger or lower inclination angle to the adjoining support frame 2 than the rotational plane R or it may not be inclined at all.

In any of the examples or embodiments described here, the circular blade 6 may be arranged such that a part of the blade 6 is located vertically higher than a directly adjacent upward-facing surface of the support frame 2 and a part of the blade 6 is located vertically lower than a directly adjacent upward-facing surface of the support frame 2. The blade 6 may, for example, be located lower than the adjacent support frame 2 upper surface over at least 10°, 30° or 50° of the circular blade circumference. The adjacent upper surface may be made up by the upward-facing surface of the circular subframe 8, whereby a part of the circular subframe 8 (for example 90° of the circumference) is located vertically higher than the blade 6 and another part of the circular subframe 8 (for example 270° of the circumference) is located vertically lower than the blade 6, as for example illustrated in FIG. 4. In the region in which the blade 6 is located lower than the subframe 8, the subframe 8 will thereby prevent the receptacle from coming into contact with the blade 6.

As an additional or alternative suggestion to providing an inclined rotational plane R of the blade 6, it may be advantageous to cover the circular blade 6 at least partially towards the receptacle bottom of a loaded receptacle. By means of a partially covered blade 6, it is also possible to ensure limited cutter exposure to the receptacle, thus preventing complete cutouts from the receptacle. For instance, the cover may be a shield made of metal or other suitable robust material. The cover may protrude from the support frame 2 over the blade 6 and it may cover preferably at least 10, 30 or 50% of the cutting edge of the blade 6 or preferably at least 10°, 30° or 50° of the circular blade circumference. In this manner, when a receptacle is positioned on the support frame 2, it may partially rest on the cover and thereby be prevented from contact with the blade 6 in the covered region.

As illustrated exemplarily throughout the figures, the handling device 1 further comprises a reservoir 10 mounted to the support frame 2. By means of the reservoir 10, which may for example have a frustopyramidal shape, the bulk material discharged from the flexible large-volume receptacle may be collected and guided to a defined outlet at the lower part of the reservoir 10. The outlet of the reservoir 10 forms an interface to downstream processing equipment, and may comprise a simple outlet opening 11 for direct discharge (see FIG. 4) or for example an outlet port, valve or dosing screw which is selectively closable or variable in order to enable control of the discharge of material. The interface may be positioned above a target container, an intermediate reservoir or a supply line for further transporting or processing of the discharged material. A separate collector 15 may be attached to the underside of the reservoir 10 for this purpose.

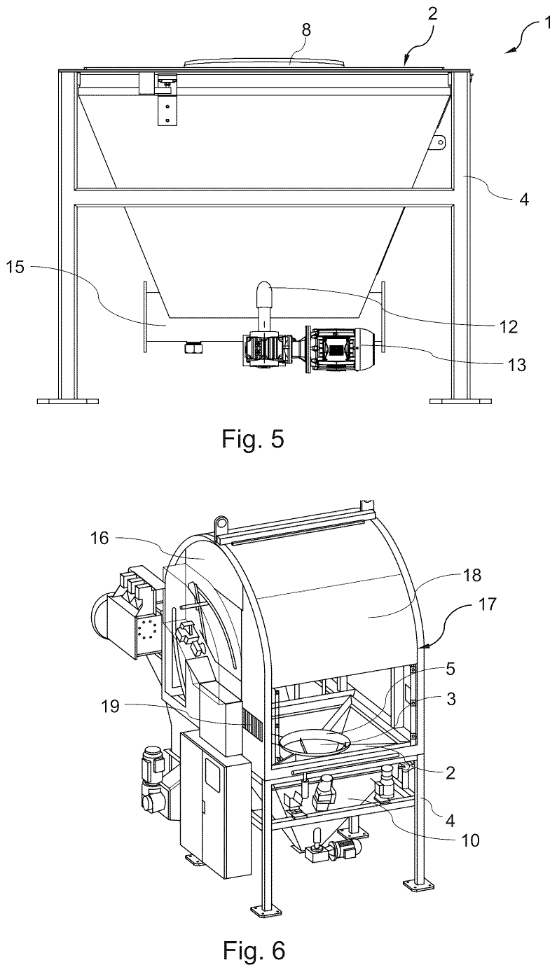

As illustrated for example in FIG. 5, the reservoir 10 preferably comprises a shaft opening 12 through which the cutter shaft 9 may protrude into the inside of the reservoir 10 and towards the support frame 2. The cutter drive 13 for driving the cutter shaft 9 and the rotary cutter 5 may be placed on the outside and at a lower part of the reservoir 10 in order to achieve a compact arrangement.

The handling device 1 may have a modular configuration, i.e. such that it may be split into smaller modules e.g. for transport, maintenance or component exchange. For instance, the handling device 1 may comprise a frame module comprising the rack 4 and the support frame 2; a cutting module comprising the cutter 5, the blade 6, the cutter shaft 9 and the cutter drive 13; and a collector module comprising the reservoir 10 and the collector 15.

Although not depicted in single method steps, an associated handling method for flexible large-volume receptacles can be derived from FIGS. 1 to 5 comprising the steps of:
providing a handling device 1;
loading a flexible large-volume receptacle containing bulk material on the support frame 2 such that the support frame 2 supports a receptacle bottom of the receptacle;
activating the rotary cutter 5;
cutting an arch into the receptacle bottom by means of the rotary cutter 5; and
discharging the bulk material from the receptacle.

The described method may further comprise a step of deactivating the rotary cutter 5 after the step of cutting an arch into the receptacle bottom for unhindered material flow and reduced energy consumption. The described method may further comprise a step of collecting the discharged bulk material in a reservoir 10 and/or a collector 15 for controlled release of the bulk material to downstream equipment. The described method may further comprise a step of adjusting the cutter shaft height or angle before or after loading a flexible large-volume receptacle on the support frame 2 for individual configuration.

In accordance with the preceding description of handling devices and methods, fast, effective and reliable cutting of the receptacle bottom can be achieved.

FIG. 6 illustrates a handling device 1 for handling flexible large-volume receptacles containing bulk material according to another example. The handling device 1 comprises a support frame 2 with at least one opening 3. The support frame 2 is mounted to a rack 4, which is configured to hold and stabilize the support frame 2 in a suitable height. The support frame 2 is configured to support a receptacle bottom of a flexible large-volume receptacle which is loaded onto the support frame 2. The handling device 1 may otherwise comprise any of the additional features described in relation to FIGS. 1-5 above, or a combination thereof.

As illustrated, the rack 4 further comprises a casing 16 mounted to the rack 4. The casing 16 is configured to substantially cover the sides and the top of the handling device 1. In addition, the casing 16 comprises a selectively openable and closable loading section 17. By means of the selectively openable and closable loading section 17, temporary access may be provided to the support frame 2 for loading or unloading a flexible large-volume receptacle to or from the handling device 1. Preferably, the loading section 17 is intended to be closed during the discharge of material from the receptacle. By means of the casing 16 and the closed loading section 17, a contamination-free or dust-free discharge of bulk material is provided, thus protecting staff and machinery in the direct environment. In addition, it is prevented that material from outside the casing 16 infiltrates the discharged material, thus preventing contamination. Due to the substantially closed handling system, high flow rates for discharging material may be implemented without contamination-based restrictions or issues relating to dust generation.

As indicated in FIG. 6, the handling device 1 may comprise a rotary cutter 5, a piercer or another suitable mechanism for opening the flexible large-volume receptacles at the bottom.

The selectively openable and closable loading section 17 may comprise a movable, e.g. pivotable door in order to provide selective access to the inner volume of the casing 16. According to the advantageous embodiment depicted in FIG. 6, the casing 16 comprises a roller shutter 18. By means of a roller shutter 18, a well-defined, fast, reliable and controllable opening and closing of the loading section 17 can be achieved. Suitable anti-collision or contamination sensors may be provided to monitor the loading section area for critical objects or particles, accordingly inhibiting the roller shutter 18 to close or to open.

As the casing 16 presents a seal which may affect pressure conditions in the inner volume of the casing 16 when the loading section 17 is in a closed state, it may be preferable that the casing 16 comprises an air exchange unit 19. The air exchange unit 19 may have a filter assembly, or optionally it may be connected to a ventilation system. The air exchange unit 19 is configured to exchange air within the casing 16 with environmental air in order to prevent contamination of the environment while enabling pressure compensation. The pressure may be monitored by means of a differential pressure gauge (not shown). The air exchange unit 19 may provide passive air exchange by natural airflow through ventilation slots or it may be configured to, at least temporarily, effect active fan-assisted air exchange. In particular with active air exchange, the dust load in the inner volume of the casing 16 can be rapidly reduced thus enabling faster unloading and loading of receptacles between discharge processes, which leads to reduced operation times. The filter assembly may comprise exchangeable filter cassettes. The air exchange unit 19 may furthermore comprise a purge air source for quickly purifying the dust laden air in the inner volume of the casing 16.

The handling device 1 may comprise a modular configuration, i.e. may be split into smaller modules e.g. for transport, maintenance or component exchange. For instance, the handling device 1 may comprise a frame module comprising the rack 4, the casing 16 with the roller shutter 18, and the support frame 2; a cutting module comprising a cutter 5; an air exchange module comprising the air exchange unit 19 and a filter assembly; and a collector module comprising the reservoir 10 and the collector 15.

Although not depicted in single method steps, an associated handling method for flexible large-volume receptacles can be derived from FIG. 6 comprising the steps of:
providing a handling device 1;
opening the loading section 17 of the casing 16;
loading a flexible large-volume receptacle containing bulk material on the support frame 2;
closing the loading section 17 of the casing 16; and
discharging the bulk material from the receptacle.

The described method may further comprise a step of unloading a preceding flexible large-volume receptacle from the support frame 2 before loading a new flexible large-volume receptacle on the support frame. The described method may further comprise a step of cutting or piercing the receptacle bottom of the flexible large-volume receptacle before discharging the bulk material from the receptacle. The described method may further comprise a step of activating the air exchange unit 19. The described method may further comprise a step of sensor-assisted approval of opening or closing the loading section 17.

In accordance with the preceding description of handling devices and methods, clean, fast and effective discharge of bulk material from flexible large-volume receptacles without contamination of the environment can be achieved.

The handling devices 1 and the associated handling methods described in relation to FIGS. 1-5 above may explicitly be combined with one or more feature or step of handling devices 1 and handling methods described in relation to FIG. 6 in order to beneficially realise the advantages of improved cutting with improved dust prevention. The handling devices 1 and methods according to these examples comprise coinciding and synergistic approaches to provide fast, reliably and efficiently working handling devices 1 and methods. For example, in some applications, operation cycle times may be reduced to ranges of 5-10 minutes, e.g. 7 or 8 minutes, between loading and unloading a flexible large-volume receptacle.

FIGS. 7-13 illustrate aspects of a handling device having an internal sack handling mechanism. The features shown in FIGS. 7-13 may be used in conjunction with one or more of the examples above, or on their own.

The handling device 1 is configured to receive a receptacle 30 containing bulk material. The device 1 comprises a loading section 17 which can be selectively opened and closed, similarly as described above in relation to FIG. 6. The receptacle 30 can be moved into the device 1 and positioned for delivery into a reservoir 10.

A gripper assembly 31 is movably arranged in the casing 16. In FIGS. 7 and 8, the gripper assembly 31 is arranged in a retracted position as the receptacle 30 is loaded into the casing 16.

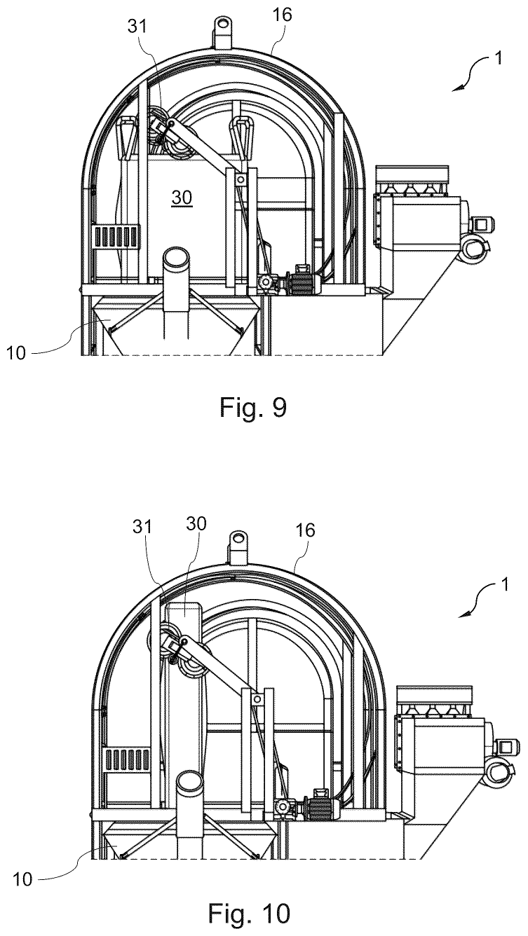

In FIG. 9, the gripper assembly 31 is moved to an advanced position, in which it is operable to make contact with the top of the receptacle 30. The gripper assembly 31 may, for example, be arranged pivotable between the retracted and the advanced positions, as indicated in FIGS. 7-9.

The gripper assembly 31 may comprise a gripper drum, described in further detail below, which makes contact with the receptacle 30. The blade 6 (or another type of cutting mechanism) is then activated and material is emptied from the receptacle 30 into the reservoir 10, illustrated in FIG. 10. The gripper assembly 31 holds the receptacle 30 during this process. After some time, the receptacle 30 can be considered emptied. A weight sensor (not shown) may, for example, be used for the purpose of determining when the receptacle 30 should be considered emptied, and/or this may be determined based on time lapsed since activating the cutting of the receptacle 30.

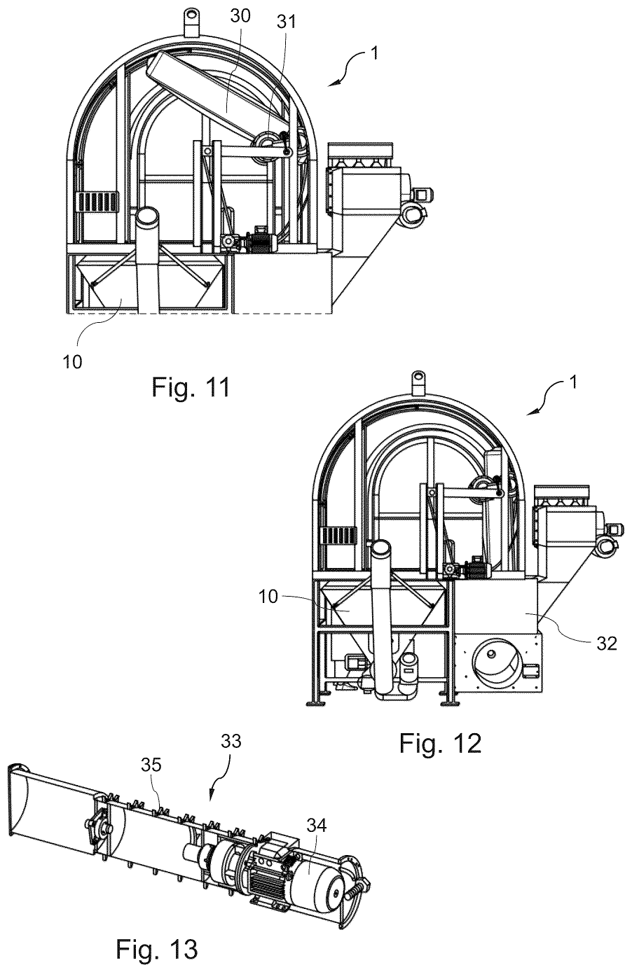

Illustrated in FIG. 11, the gripper assembly 31 may then be retracted towards the retracted position, with the substantially empty receptacle 30 being pulled along, away from the reservoir 10.

Illustrated in FIG. 12, when the gripper assembly 31 is in the retracted position, it may be arranged above a disposal unit 32 for the emptied receptacle 30, for example a sack compactor. In this position, the gripper drum (if used) may be rotated to feed the substantially empty receptacle 30 into the disposal unit 32.

FIG. 13 illustrates a gripper drum 33 according to one example. The gripper drum 33 can be motorized, for example having a motor 34 within its housing, in order to rotate the gripper drum 33 or parts of the gripper drum 33 relative to the rest of the gripper assembly 31.

Gripper members 35, such as protrusions extending radially outwardly on the surface of the gripper drum 33, may be provided to enhance the engagement of the receptacle 30.

The gripper assembly 31 may comprise two gripper drums between which the receptacle 30 can be engaged. In any of the examples or embodiments having two gripper drums, one gripper drum 33 may, for example, be motorized as illustrated in FIG. 13 and one may be passive, or both may be motorized. Additionally, or alternatively, one gripper drum may be spring-loaded such as to allow for any clumps or remains in the receptacle 30 to pass between the gripper drums when the substantially empty receptacle 30 is fed to the disposal unit 32.

The invention is not limited by the embodiments and examples described above; reference should be had to the appended claims.

LIST OF REFERENCE NUMBERS

| | | | |
|---|---|---|---|
| 1 | handling device | 16 | casing |
| 2 | support frame | 17 | loading section |
| 3 | opening | 18 | roller shutter |
| 4 | rack | 19 | air exchange unit |
| 5 | cutter | 30 | receptacle |
| 6 | blade | 31 | gripper assembly |
| 7 | support strut | 32 | disposal unit |
| 8 | subframe | 33 | gripper drum |
| 9 | cutter shaft | 34 | motor |
| 10 | reservoir | 35 | gripper members |
| 11 | outlet opening | H | horizontal |
| 12 | shaft opening | R | rotational plane |
| 13 | cutter drive | α | inclination angle |
| 15 | collector | β | tilt angle |

1. Handling device for handling flexible receptacles containing bulk material, comprising:
a support frame with at least one opening, wherein the support frame is configured to support a receptacle bottom of a loaded receptacle; and
a cutter at least partially protruding into the opening of the support frame and configured to cut the receptacle bottom;
wherein the cutter is a rotary cutter with a circular blade defining a rotational plane.

2. The handling device according to claim 1, wherein the rotational plane of the blade is inclined to the support frame at a predefined inclination angle.

3. The handling device according to claim 1, wherein at least a section of the support frame is tilted relative to the horizontal at a predefined tilt angle.

4. The handling device according to claim 1, wherein the circular blade is at least partially covered towards the receptacle bottom of a loaded receptacle.

5. The handling device according to claim 1, wherein the support frame comprises at least one support strut.

6. The handling device according to claim 1, wherein at least two support struts are arranged in a substantially cruciform manner.

7. The handling device according to claim 1, wherein the support frame comprises a circular subframe into which the cutter projects.

8. The handling device according to claim 1, wherein a cutter height and/or a cutter angle are adaptable by means of an adjustable cutter shaft.

9. The handling device according to claim 1, wherein the handling device further comprises a reservoir mounted to the support frame.

10. Method for handling flexible receptacles containing bulk material, the method comprising the steps of:
providing a handling device according to any preceding claim;
loading a flexible receptacle containing bulk material on the support frame such that the support frame supports a receptacle bottom of the receptacle;
activating the rotary cutter;
cutting an arch into the receptacle bottom by means of the rotary cutter; and
discharging the bulk material from the receptacle.

11. Handling device for handling flexible receptacles containing bulk material, the device comprising:
a support frame with at least one opening, wherein the support frame is configured to support a receptacle bottom of a loaded receptacle; and
a rack to which the support frame is mounted;
wherein the handling device further comprises a casing mounted to the rack with a selectively openable and closable loading section.

12. The handling device according to claim 11, wherein the loading section of the casing comprises a shutter, such as a slidable shutter or a roller shutter.

13. The handling device according to claim 11, wherein the casing comprises an air exchange unit fluidly connected to an inner volume of the casing, for example an air exchange unit having a filter assembly.

14. The handling device according to claim 11, further comprising a sack handling mechanism with a gripper assembly arranged in the casing,
the gripper assembly being movable between a retracted position and an advanced position in which it is operable to make contact with a top of the receptacle arranged at the support frame.

15. The handling device according to claim 14, wherein the retracted position is a position adjacent, such as above, a disposal unit for the receptacle.

16. The handling device according to claim 14, wherein the gripper assembly comprises at least one gripper drum.

17. The handling device according to claim 16, wherein the gripper drum is motorized, for example having a motor within its housing, in order to rotate the gripper drum or parts of the gripper drum relative to the rest of the gripper assembly.

18. The handling device according to claim 16, wherein the gripper drum comprises gripper members, such as protrusions extending radially outwardly on the surface of the gripper drum.

19. The handling device according to any of claim 14, wherein the gripper assembly comprises two gripper drums between which the receptacle can be engaged.

20. The handling device according to any of claim 11, wherein the handling device is further configured as a handling device according to any of claims 1 to 9.

21. Method for handling flexible receptacles, the method comprising the steps of:
providing a handling device according to claim 11;
opening the loading section of the casing;
loading a flexible receptacle containing bulk material on the support frame;
closing the loading section of the casing; and
discharging the bulk material from the receptacle.
